(19) United States
(12) Patent Application Publication
(10) Pub. No.: US 2020/0325011 A1
(43) Pub. Date: Oct. 15, 2020

(54) SYSTEM AND METHOD FOR DISPENSING A LIQUID, IN PARTICULAR IN A HOUSEHOLD APPLIANCE

(71) Applicant: ELBI INTERNATIONAL S.P.A., Torino (IT)

(72) Inventors: Giorgio CARRER, Torino (IT); Luca GARETTO, Rivoli (TO) (IT); Marco BECCHIO, Carignano (TO) (IT); Paolo RAVEDATI, Moncalieri (TO) (IT)

(21) Appl. No.: 16/818,777

(22) Filed: Mar. 13, 2020

(30) Foreign Application Priority Data
Mar. 13, 2019 (IT) 10-2019-000003633

(51) Int. Cl. B67D 3/00; D06F 33/37; D06F 34/14; D06F 39/02; A47L 15/44; A47L 15/00

(52) U.S. Cl. CPC B67D 3/0077; D06F 33/37; D06F 34/14; D06F 2103/14; A47L 15/4418; A47L 15/0028; D06F 39/022

(57) ABSTRACT

A vessel contains a quantity of liquid and has a duct connected to an outlet of the vessel. A dispensing device can be actuated in order to cause the quantity of liquid to flow out of the vessel through the duct. A color sensor is also included, which faces towards a monitoring region situated in one of the vessel, the duct and the dispensing device. The color sensor is configured for providing a color signal indicative of the color of the quantity of liquid arriving at the monitoring region. A control device is configured for receiving the color signal from the color sensor and for actuating the dispensing device as a function of the color signal. A method is for dispensing the quantity of liquid from the vessel.

### TECHNICAL FIELD

The present invention relates to a system and a method for dispensing a liquid, in particular in a household appliance.

### BACKGROUND ART

Systems and methods are known in the art for dispensing a liquid contained in a vessel.

Such systems and methods find application in many technical fields and spheres. By way of non-limiting example, the above-mentioned systems are especially used in household appliances, particularly but not exclusively in washing machines, such as laundry washing machines and dishwashers.

However, the systems and methods known in the art suffer from some drawbacks that the present invention intends to overcome.

### SUMMARY OF THE INVENTION

It is one object of the present invention to provide a system and a method for dispensing a liquid, in particular in a household appliance, wherein such system and method are of an improved and reliable type.

According to the present invention, this and other objects are achieved through a system and a method as defined in the appended independent claims.

It is understood that the appended claims are an integral part of the technical teachings provided in the following detailed description of the present invention. In particular, the appended dependent claims define some preferred embodiments of the present invention that include some optional technical features.

Further features and advantages of the present invention will become apparent in light of the following detailed description, provided merely as a non-limiting example and referring, in particular, to the annexed drawings, which will be briefly summarized below.

### BRIEF DESCRIPTION OF THE DRAWINGS

FIGS. 1 to 3 are block diagrams representing a plurality of different systems for dispensing a liquid, each one of them being designed in accordance with a respective exemplary embodiment of the present invention.

FIGS. 4 to 6 are schematic and partial sectional views of some structural details of a plurality of different systems for dispensing a liquid, each one of them being designed in accordance with a respective exemplary embodiment of the present invention.

### DETAILED DESCRIPTION OF THE INVENTION

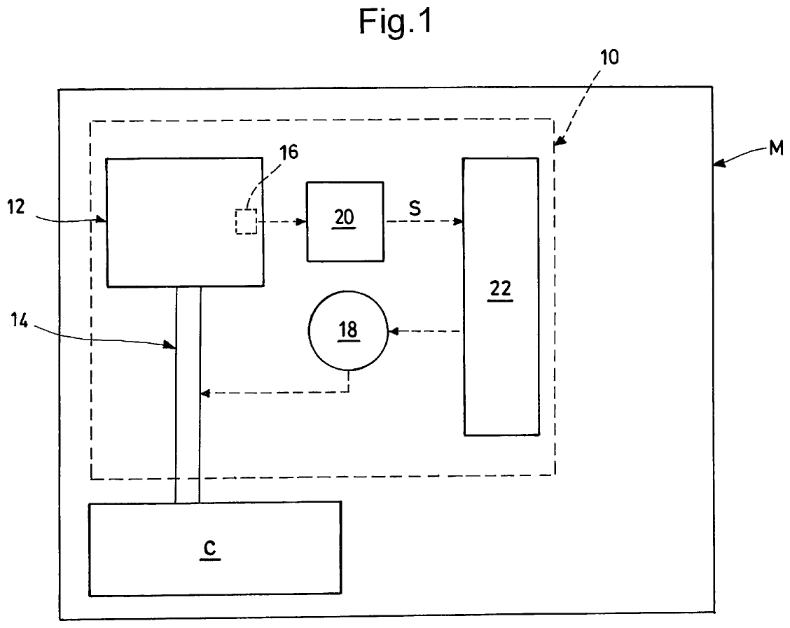

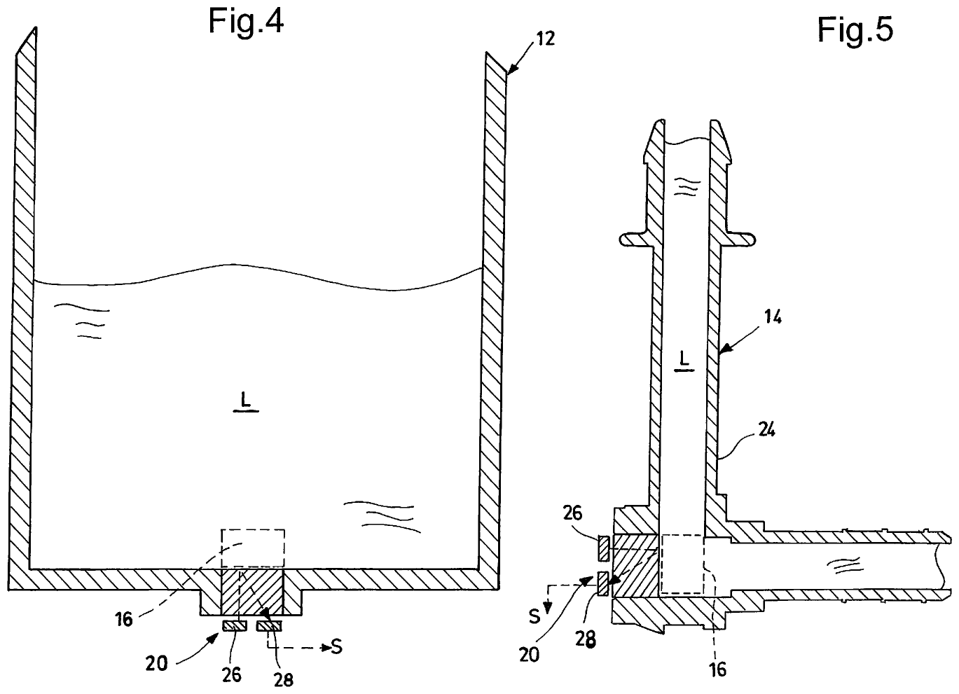

With particular reference to FIGS. 1 and 4, there is shown a system, designated as a whole as 10, made in accordance with a first exemplary embodiment of the present invention.

As will be described more in detail below, system 10 is configured for dispensing a liquid. As will become apparent to a person skilled in art from reading the following detailed description, system 10 is suitable for application in numerous technical fields and spheres. In particular, by way of non-limiting example, system 10 is suitable for integration in a household appliance, such as a washing machine M (e.g. a laundry washing machine or a dishwasher).

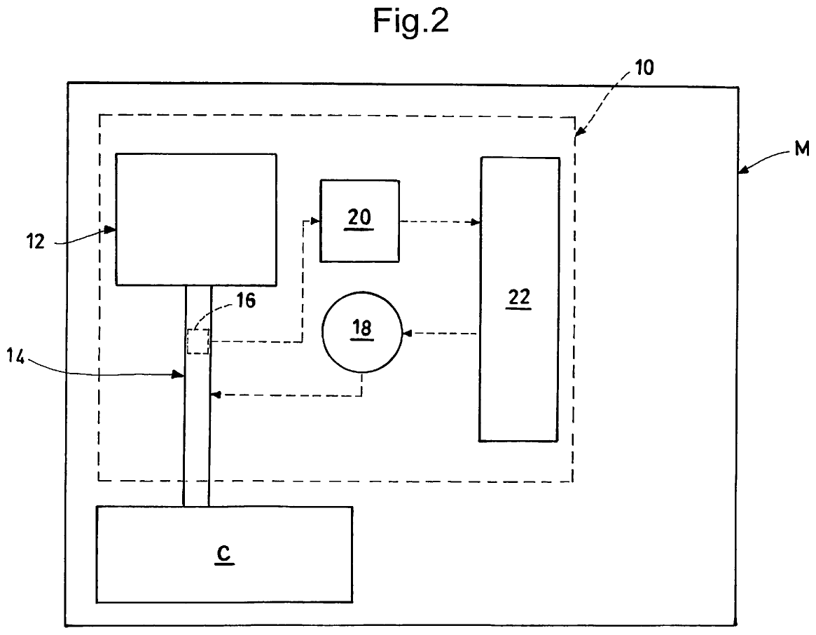

With particular reference to FIG. 2, system 10 comprises a vessel 12 that can contain a quantity of liquid L. For example, vessel 12 may be a reservoir for a liquid, such as a washing or rinsing agent of a washing machine.

System 10 comprises also a duct 14 connected to the outlet of vessel 12. Duct 14 is configured for allowing the quantity of liquid L to flow out of vessel 12. In particular, duct 14 may end into or enter a chamber of the household appliance in which system 10 may be installed, e.g. a wash chamber C of washing machine M.

System 10 is also equipped with a dispensing device 18, which can be actuated in order to cause the quantity of liquid L to flow out of vessel 12 through duct 14.

Furthermore, system 10 comprises a colour sensor 20 facing towards a monitoring region 16. Colour sensor 20 is configured to provide a colour signal S indicative of the colour of the quantity of liquid L arriving at monitoring region 16.

In the first embodiment illustrated herein by way of example with particular reference to FIG. 4, monitoring region 16 is situated in an inner portion (e.g. at the bottom) of vessel 12. However, as will be described below, monitoring region 16 may clearly be located in different positions in the system 10.

In addition, system 10 further comprises a control device 22 configured for receiving a colour signal S. Control device 22 is configured for actuating dispensing device 18 as a function of colour signal S, i.e. as a function of the colour detected by colour sensor 20.

Thus, control device 22 can be configured for recognizing the type and/or the characteristics of the quantity of liquid L contained in vessel 12 on the basis of the detection made by colour sensor 20. Depending on the colour detected, control device 22 can appropriately actuate dispensing device 18 to effect the distribution of the quantity of liquid L automatically and appropriately according to the recognized type and/or characteristics.

For example, if the colour detected by colour sensor 20 is the one associated with a type of liquid having known properties or characteristics (e.g. a washing agent having a predetermined colour), control device 22 will actuate dispensing device 18 in order to dispense a predetermined part or dose of the quantity of liquid L contained in vessel 12 in one or more predefined periods of time during a working cycle of the household appliance. Vice versa, if the detected colour is associated with another type of liquid having different properties or characteristics (e.g. a rinsing agent having a different predetermined colour), control device 22 will actuate dispensing device 18 in order to dispense a different predetermined part or dose of said quantity of liquid L in one or more different predefined periods of time during the working cycle of the household appliance.

In particular, colour sensor 20 is configured for being in contact with the quantity of liquid L situated in monitoring region 16.

In this embodiment, colour sensor 20 is carried by the side walls of vessel 12, e.g. of the bottom thereof.

In the first embodiment illustrated in FIGS. 1 and 4, as aforementioned, colour sensor 20 faces towards monitoring region 16 of vessel 12. Colour signal S is, therefore, indicative of the colour of the quantity of liquid L situated in monitoring region 16 of vessel 12.

Particularly, colour sensor 20 is of the optical type.

Preferably, colour sensor 20 comprises an emitter 26, e.g. a light emitting diode or LED, configured for emitting light intended to optically interact with the quantity of liquid L situated in monitoring region 16. In addition, colour sensor 22 comprises a receiver 28, e.g. a spectrometer, configured for receiving the light that has optically interacted with the quantity of liquid L situated in monitoring region 16 and for detecting the spectrum of said light, so as to generate the above-mentioned colour signal S.

The above-mentioned spectrometer is configured for operating in per se known modes, which will not therefore be further described in detail below.

In the first embodiment illustrated in FIGS. 1 and 4, emitter 26 and receiver 28 face the same side of monitoring region 16, in particular on the same side of vessel 12. In this case, receiver 28 is configured for receiving the light spectrum reflected by the quantity of liquid L situated in monitoring region 16.

According to implementation variants that are alternative to the above, the emitter and the receiver may face each other from opposite sides of the monitoring region. In this other case, the receiver may be configured for receiving the refracted light spectrum that has crossed the quantity of liquid situated in the monitoring region. In such a case, advantageously but not necessarily, the emitter and the receiver between which the monitoring region is situated may be arranged in a narrowing or tapering portion of the vessel.

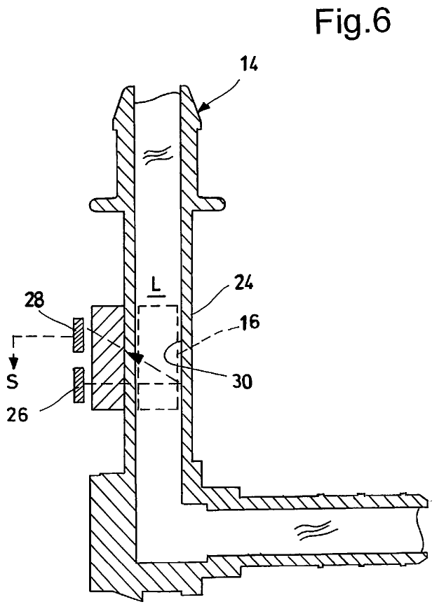

In the second embodiment illustrated in FIGS. 2 and 5, monitoring region 16 is situated in duct 14. In particular, colour signal S is indicative of the colour of the quantity of liquid L situated in, or flowing through, duct 14.

Particularly, colour sensor 20 is carried by the side walls of duct 14.

Preferably, duct 14 is a connection tube 24 hydraulically connected to vessel 12 on one side and, on the other side, connectable to the inlet of a chamber situated in the household appliance (e.g. a wash chamber C of a washing machine M).

In the second embodiment, with particular reference to FIG. 5, monitoring region 16 is situated in an elbow of duct 14.

In the second embodiment illustrated herein, still with reference to FIG. 5, emitter 26 and receiver 28 face the same side of duct 14 and also of monitoring region 16. In this case as well, receiver 28 is configured for receiving the light spectrum reflected by the quantity of liquid L.

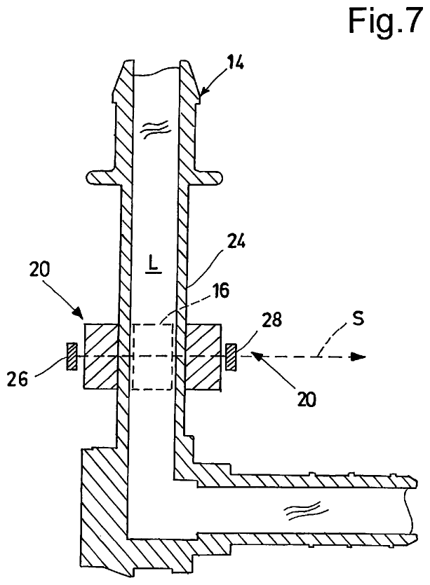

With reference to FIG. 6, there is shown a third embodiment of the present invention which is similar to the one illustrated in FIG. 5.

In the above mentioned FIG. 6, monitoring region 16 is situated in a substantially straight tract of duct 14.

In the third embodiment, it is conceivable to use reflecting material for making or coating that portion of duct 14 which faces towards colour sensor 20 from the opposite side of monitoring region 16. In this way it is possible to increase the portion of light spectrum that will be reflected towards receiver 28.

With reference to FIG. 7, there is shown a fourth embodiment of the present invention which is similar to the one illustrated in FIG. 6.

In the fourth embodiment illustrated in FIG. 6, emitter 26 and receiver 28 face each other and are situated on opposite sides of duct 14 and of monitoring region 16. In this case, receiver 28 is configured for receiving the light spectrum refracted by the quantity of liquid L.

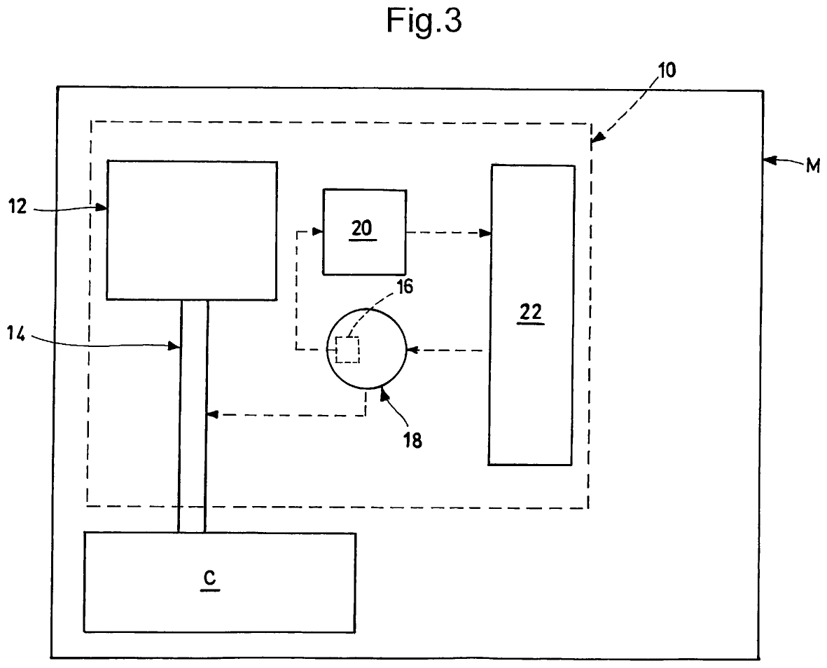

With reference to FIG. 3, there is shown a fifth embodiment of the present invention.

In the fifth embodiment, monitoring region 16 is situated in dispensing device 18.

Preferably, control device 22 is configured for determining, as a function of colour signal S, one or more of the following operating parameters of dispensing device 18:

a part or dose of the quantity of liquid L to be dispensed out of vessel 12, and

one or more periods of time in which to dispense at least one part or dose of the quantity of liquid L out of vessel 12 during a working cycle of a household appliance with which system 10 is associated.

According to further implementation variants, the system comprises also a level sensor configured for sensing the level of the quantity of liquid contained in the vessel and for sending a level signal to control device 22.

In particular, in such implementation variants control device 22 may advantageously be configured for actuating dispensing device 18 as a function of colour signal S and the level signal, according to predetermined criteria. In addition to recognizing the type and/or the characteristics of the quantity of liquid L that is present in vessel 12 on the basis of colour signal S, the control device 22 can thus adjust (e.g. activate and/or inhibit) the operation of dispensing device 18 when the level of the quantity of liquid is above or below a predetermined operating threshold. In particular, said predetermined operating threshold may vary as a function of the detected type and/or characteristics of the quantity of liquid L.

According to further implementation variants, the system may comprise also an ultrasonic sensor configured for sensing the density of the quantity of liquid contained in vessel 12 and for sending a corresponding density signal to control device 22.

In particular, in such implementation variants control device 22 may advantageously be configured for actuating dispensing device 18 as a function of not only colour signal S, but also of the density signal. For example, control device 22 may recognize the type and/or the characteristics of the quantity of liquid L that is present in vessel 12 by means of the information simultaneously obtained from colour signal S and from the density signal. Such recognition is thus effected more accurately, so that the quantity of liquid L can be discerned not only by its colour, resulting in dispensing device 18 being controlled even more reliably.

In particular, dispensing device 18 may comprise a pump associated with duct 14 (e.g. with connection tube 24) and configured for dispensing the quantity of liquid L under control of control device 22, preferably in a dosed manner. For example, said dispensing device 18 may be a peristaltic pump. In further implementation variants, said dispensing device 18 may comprise a valve associated with duct 14, the opening of which can be controlled by control device 22, wherein such valve is associated with or replaces the pump. In particular, the opening of the valve may permit the outflow by gravity of the quantity of liquid L contained in vessel 12.

In particular, control device 22 may comprise a printed circuit board or PCB connected to colour sensor 20.

Furthermore, in compliance with the above description of the system made in accordance with the exemplary embodiments and implementation variants of the present invention, a method is also implemented for dispensing a liquid, in particular in a household appliance, such as a washing machine.

Said method comprises the operating step of detecting, by means of a colour sensor 20, the colour of a quantity of liquid L contained in a monitoring region 16 situated in at least one of a vessel 12, a duct 14 connected to the outlet of said vessel 12, and a dispensing device 18 that can be actuated to cause said quantity of liquid L to flow out of said vessel 12 through said duct 14.

Said method also envisages to send, to a control device 22, a colour signal S indicative of the colour detected by colour sensor 20.

Furthermore, dispensing device 18 is actuated in a controlled manner by control device 22 as a function of the colour signal. In particular, dispensing device 18 is actuated in order to dispense, e.g. into a chamber C of the household appliance, at least one dose of the quantity of liquid L contained in vessel 12, under control of control device 22, as a function of colour signal S.

Of course, without prejudice to the principle of the invention, the forms of embodiment and the implementation details may be extensively varied from those described and illustrated herein by way of non-limiting example, without however departing from the scope of the invention as set out in the appended claims.

For example, as will be apparent to a person skilled in the art, colour sensor 20 may be positioned in any portion of system 10 situated between vessel 12, duct 14 and dispensing device 18, in particular situated in any section upstream of a chamber belonging to a household appliance (e.g. of wash chamber C of a washing machine M) where duct 14 ends or is connected.

The technical features that differentiate the various embodiments and variants thereof described and illustrated herein are freely interchangeable, whenever compatible.

1. A system for dispensing a liquid, in a household appliance; said system comprising:
a vessel for containing a quantity of liquid;
a duct connected to the outlet of said vessel;
a dispensing device, which is actuatable to cause said quantity of liquid to flow out of said vessel through said duct;
a color sensor facing towards a monitoring region situated in at least one of said vessel, said duct and said dispensing device; said color sensor being configured to provide a color signal indicative of the color of the quantity of liquid arriving at said monitoring region; and
a control device configured for receiving said color signal from said color sensor and for actuating said dispensing device as a function of at least said color signal.

2. The system according to claim 1, wherein said color sensor is an optical sensor.

3. The system according to claim 2, wherein the color sensor comprises:
an emitter for emitting light to optically interact with the quantity of liquid in said monitoring region;
a receiver configured for receiving light that has optically interacted with the quantity of liquid in said monitoring region and for detecting the spectrum of said light, to generate said signal.

4. The system according to claim 3, wherein said emitter comprises a light emitting diode.

5. The system according to claim 3, wherein said receiver comprises a spectrometer.

6. The system according to claim 2, wherein said emitter and said receiver are situated on a same side, facing towards the monitoring region.

7. The system according to claim 2, wherein said emitter and said receiver face towards each other and are situated on opposite sides of said monitoring region.

8. The system according to claim 1, wherein said monitoring region is situated in said vessel.

9. The system according to claim 1, wherein said monitoring region is situated in said duct.

10. The system according to claim 1, wherein said monitoring region is situated in said dispensing device.

11. The system according to claim 1, further comprising a level sensor configured for sensing a level of a quantity of liquid contained in said vessel and for sending a level signal to said control device; said control device being configured for actuating said dispensing device as a function of said color signal and said level signal.

12. The system according to claim 1, wherein said control device determines, as a function of said signal, at least one of the following operating parameters of said dispensing device:
a part or dose of said quantity of liquid to be dispensed out of said vessel, and
at least one period of time in which to dispense at least one part or dose of said quantity of liquid out of said vessel during a working cycle of a household appliance with which said system is associated.

13. The system according to claim 1, wherein said dispensing device comprises at least one of a pump and a valve, associated with said duct.

14. A household appliance, comprising a system made in accordance with claim 1.

15. A method for dispensing a liquid, said method comprising the following operating steps:
detecting, by a color sensor, a color of a quantity of liquid located in a monitoring region situated in at least one of a vessel, a duct connected to an outlet of said vessel, and a dispensing device actuatable to cause said quantity of liquid to flow out of said vessel through said duct;
sending to a control device a color signal indicative of said color detected by said color sensor; and
actuating said dispensing device in a controlled manner by said control device as a function of said color signal.
